(19) United States
(12) Patent Application Publication
(10) Pub. No.: US 2020/0348415 A1
(43) Pub. Date: Nov. 5, 2020

(54) TIME OF FLIGHT RANGING MODULE, OPERATING METHOD THEREOF, AND MULTIMEDIA SYSTEM

(71) Applicant: Guangzhou Tyrafos Semiconductor Technologies Co., LTD, Guangzhou (CN)

(72) Inventors: Ping-Hung Yin, Taipei City (TW); Jia-Shyang Wang, Miaoli County (TW); Teng-Chien Yu, Hsinchu City (TW)

(73) Assignee: Guangzhou Tyrafos Semiconductor Technologies Co., LTD, Guangzhou (CN)

(21) Appl. No.: 16/852,536

(22) Filed: Apr. 19, 2020

Related U.S. Application Data
(60) Provisional application No. 62/842,448, filed on May 2, 2019.

(30) Foreign Application Priority Data
Feb. 5, 2020 (TW) 109103470

(51) Int. Cl. G01S 17/10; G01S 7/4865; G01S 7/51; H04B 10/11

(52) U.S. Cl. CPC G01S 17/10; H04B 10/11; G01S 7/51; G01S 7/4865

(57) ABSTRACT

A ToF ranging module, its operating method, and a multimedia system are provided. The ToF ranging module has an optical communication function and is adapted to be disposed on an electronic device communicating with another electronic device through a wireless communication module to synchronize ToF ranging periods and optical communication periods of the two electronic devices and determine a communication order of the two electronic devices. The ToF ranging module includes a processing unit, a light sensing unit, and a light emitting unit. During the ToF ranging period, the processing unit drives the light emitting unit and the light sensing unit to perform ToF ranging to obtain distance data between the two electronic devices. During the optical communication period, the processing unit outputs the distance data and drives the light sensing unit or the light emitting unit to optically communicate with another ToF ranging module of the another electronic device.

### CROSS-REFERENCE TO RELATED APPLICATION

This application claims the priority benefits of U.S. provisional application Ser. No. 62/842,448, filed on May 2, 2019 and Taiwan application serial no. 109103470, filed on Feb. 5, 2020. The entirety of each of the above-mentioned patent applications is hereby incorporated by reference herein and made a part of this specification.

### BACKGROUND

### Technical Field

The disclosure relates to a ranging technology, and in particular to a time of flight (ToF) ranging module, an operating method thereof, and a multimedia system.

### Description of Related Art

In a conventional ToF application, an electronic device equipped with a ToF ranging module may only perform a ranging function. In other words, if the electronic device with the ToF ranging module is applied in a special application scenario, the electronic device requires other additional modules to perform other functions. For instance, a multimedia system, such as a virtual reality (VR) system or an augmented reality (AR) system, may include a plurality of wearable electronic devices and may be operated in a multi-player mode. Since ranging and communications among the wearable electronic devices are required, the conventional electronic device equipped with the ToF ranging module also needs an additional wireless communication module, thus increasing device demands and costs for the wearable electronic devices. In view of the above, several solutions described in the embodiments below are proposed.

### SUMMARY

The disclosure provides a ToF ranging module, an operating method thereof, and a multimedia system, which may provide an effective ToF ranging function and an optical communication function to be applied in the multimedia system.

According to an embodiment of the disclosure, a ToF ranging module has an optical communication function and is adapted to be disposed on an electronic device. The electronic device also includes a wireless communication module. The wireless communication module is configured to communicate with another electronic device to synchronize a ToF ranging period and an optical communication period of the electronic device and a ToF ranging period and an optical communication period of the another electronic device and determine a communication order of the two electronic devices. The ToF ranging module includes a processing unit, a light sensing unit, and a light emitting unit. The processing unit is coupled to the wireless communication module, the light sensing unit, and the light emitting unit. During the ToF ranging period, the processing unit drives the light emitting unit and the light sensing unit to perform ToF ranging to obtain distance data between the electronic device and the another electronic device. During the optical communication period, the processing unit outputs the distance data and drives the light sensing unit or the light emitting unit to optically communicate with another ToF ranging module of the another electronic device.

In an embodiment of the disclosure, during the ToF ranging period, the light emitting unit emits sensing light to the another electronic device, and the light sensing unit receives reflected light reflected from the another electronic device.

In an embodiment of the disclosure, the processing unit calculates a distance between the electronic device and the another electronic device according to a difference between a time of emitting the sensing light by the light emitting unit and a time of receiving the reflected light by the light sensing unit.

In an embodiment of the disclosure, the ToF ranging period and the optical communication period are not overlapped and are interleaved.

In an embodiment of the disclosure, the light sensing unit is a photodiode, and the light emitting unit is a light emitting diode (LED) or a laser diode.

In an embodiment of the disclosure, the electronic device and the another electronic device are operated in a VR system or an AR system.

According to an embodiment of the disclosure, a multimedia system includes a first electronic device and a second electronic device. The first electronic device communicates with the second electronic device through a wireless communication module to synchronize a ToF ranging period and an optical communication period of the first electronic device and a ToF ranging period and an optical communication period of the second electronic device and determine a communication order of the first and second electronic devices. The first electronic device performs time of flight ranging through a light emitting unit and a light sensing unit of a time of flight ranging module during the ToF ranging period to obtain distance data between the first electronic device and the second electronic device. The first electronic device outputs the distance data through the ToF ranging module during the optical communication period and optically communicates with another ToF ranging module of the second electronic device through the light sensing unit or the light emitting unit.

According to an embodiment of the disclosure, an operating method of a ToF ranging module is adapted to the ToF ranging module. The ToF ranging module is disposed on the electronic device, and the electronic device includes a wireless communication module. The operating method of the ToF ranging module includes following steps: communicating with another electronic device through the wireless communication module of the electronic device to synchronizing a ToF ranging period and an optical communication period of the electronic device and a ToF ranging period and an optical communication period of the another electronic device and determine a communication order of the two electronic devices. During the ToF ranging period, a light emitting unit and a light sensing unit of the ToF ranging module are driven to perform ToF ranging to obtain distance data between the electronic device and the another electronic device; during the optical communication period, the distance data are output by the ToF ranging module, and the light sensing unit or the light emitting unit of the ToF ranging module is driven to optically communicate with another ToF ranging module of the another electronic device. The ToF ranging module is disposed on the electronic device.

Based on the above, the ToF ranging module, the operating method thereof, and the multimedia system as provided in one or more embodiments of the disclosure may perform the ToF ranging and the optical communication in a time division manner through the light sensing unit and the light emitting unit of the ToF ranging module.

Several exemplary embodiments accompanied with figures are described in detail below to further describe the disclosure in details.

### BRIEF DESCRIPTION OF THE DRAWINGS

Reference will now be made in detail to the present preferred embodiments of the disclosure, examples of which are illustrated in the accompanying drawings. Wherever possible, the same reference numbers are used in the drawings and the description to refer to the same or like parts.

FIG. 1 is a schematic diagram of a ToF ranging module according to an embodiment of the disclosure.

FIG. 2 illustrates a time sequence relationship between a ToF ranging period and an optical communication period according to an embodiment of the disclosure.

FIG. 3 is a schematic diagram of a multimedia system according to an embodiment of the disclosure.

FIG. 4 is a flowchart of an operating method of a ToF ranging module according to an embodiment of the disclosure.

### DESCRIPTION OF THE EMBODIMENTS

In order to make the content of the disclosure easier to understand, the following specific embodiments are provided as to how the disclosure can be implemented. In addition, wherever possible, the same reference numbers of components/elements/steps are used in the drawings and embodiments to represent the same or similar components/elements/steps.

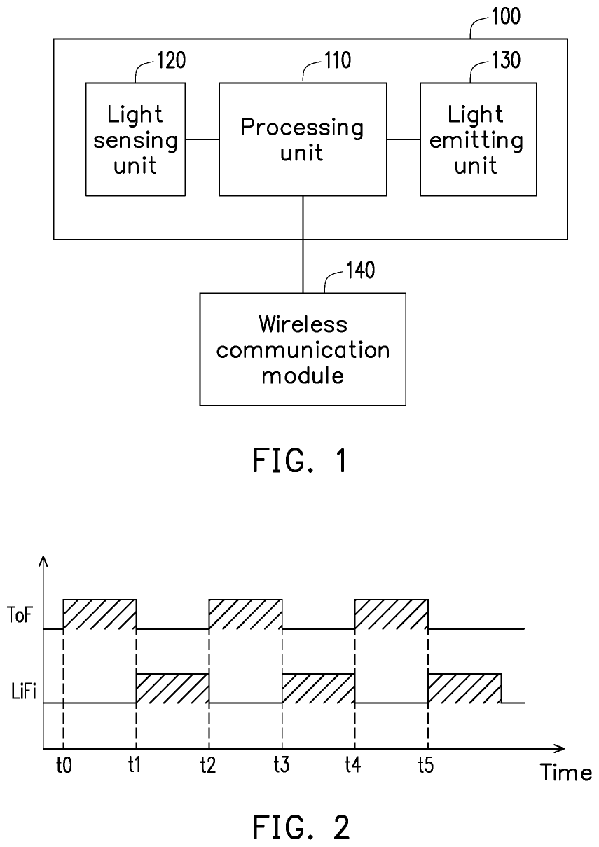

FIG. 1 is a schematic diagram of a ToF ranging module according to an embodiment of the disclosure. With reference to FIG. 1, a ToF ranging module 100 includes a processing unit 110, a light sensing unit 120, and a light emitting unit 130. The light sensing unit 120 is coupled to the processing unit 110. The light emitting unit 130 is coupled to the processing unit 110. In the embodiment, the ToF ranging module 100 is adapted to be disposed on an electronic device and is configured to perform ranging and wireless communication on another electronic device. Note that the ToF ranging module 100 provided in the embodiment achieves the ranging function and the wireless communication function through the same light sensing unit 120 and the same light emitting unit 130. In the embodiment, the processing unit 110 of the ToF ranging module 100 is also coupled to an external wireless communication module 140. The wireless communication module 140 is configured to communicate with another ToF ranging module of another electronic device in advance, so as to synchronize a ToF ranging period and an optical communication period of the electronic device and a ToF ranging period and an optical communication period of the another electronic device and determine a communication order of the two electronic devices. The wireless communication module 140 may be, for instance, a Wi-Fi module.

In the embodiment, the processing unit 110 may include a read-out circuit, an analog-to-digital converter (ADC) circuit, a digital signal processor (DSP) circuit, and other related driving circuits, and the disclosure is not limited thereto. In the embodiment, the light sensing unit 120 may be a photodiode (PD), and the light emitting unit 130 may be an LED or a laser diode (LD). In the embodiment, the ToF ranging module 100 may achieve a ranging function through applying a direct ToF (D-ToF) method or an indirect ToF (I-ToF) method.

Specifically, during the ToF ranging period, the processing unit 110 drives the light sensing unit 120 and the light emitting unit 130 to perform ToF ranging. The light emitting unit 130 may emit sensing light to another electronic device, and the sensing light is reflected on a surface of the another electronic device, so that the light sensing unit 120 may receive reflected light reflected from the another electronic device. Therefore, the processing unit 110 may calculate a distance between the electronic device and the another electronic device according to a difference between a time of emitting the sensing light by the light emitting unit 130 and a time of receiving the reflected light by the light sensing unit 120. However, since the sensing result of the light sensing unit 120 is read out via a read-out circuit (not shown), another data read-out period is required for the read-out circuit to output distance data to a DSP circuit (not shown), and the light sensing unit 120 and the light emitting unit 130 at this time are in an idle state. The ToF ranging module 100 provided in the embodiment employs the data read-out period for optical communication. The optical communication in the embodiment refers to an information transmission technology over the Internet with use of visible or invisible light, and said technology is also referred to as light fidelity (Li-Fi).

Therefore, further, when the read-out circuit of the ToF ranging module 100 outputs the distance data, the processing unit 110 may drive the light sensing unit 120 to receive an optical communication signal emitted by another ToF ranging module of the another electronic device. Alternatively, the processing unit 110 may drive the light emitting unit 130 or another light emitting unit (at a different frequency band) to emit an optical communication signal to another ToF ranging module of the another electronic device. In other words, the ToF ranging module 100 provided in an embodiment of the disclosure may perform ToF ranging and optical communication in a time division manner with use of at least one of the light sensing unit and the light emitting unit of the ToF ranging module to, which will be exemplified below with reference to the time sequence relationship illustrated in FIG. 2.

FIG. 2 illustrates a time sequence relationship between a ToF ranging period and an optical communication period according to an embodiment of the disclosure. With reference to FIG. 1 and FIG. 2, as shown in a time sequence ToF, during the ToF ranging period (shown by the oblique lines at the time sequence ToF), the light emitting unit 130 and the light sensing unit 120 of the ToF ranging module 100 perform ToF ranging to obtain distance data between the electronic device and another electronic device. The ToF ranging period (shown by the oblique lines at the time sequence ToF) refers to a period from a time point t0 to a time point t1, the period from a time point t2 to a time point t3, and the period from a time point t4 to a time point t5, for instance. Next, during a period of reading out the distance data in the time sequence ToF (not shown by oblique lines at the time sequence ToF), the light sensing unit 120 and the light emitting unit 130 are in an idle state and may be configured for optical communication. Therefore, as shown by a time sequence Li-Fi, during the optical communication period (shown by the oblique lines at the time sequence Li-Fi), the ToF ranging module 100 may optically communicate with the ToF ranging module of another electronic device with use of the light sensing unit 120 or light emitting unit 130, so as to increase the usage efficiency of the light sensing unit 120 or the light emitting unit 130 and perform additional optical communication functions. The optical communication period (shown by the oblique lines at the time sequence Li-Fi) refers to a period from the time point t1 to the time point t2 and a period from the time point t3 to the time point t4. Next, during a period of reading out the optical communication data in the time sequence Li-Fi (not shown by oblique lines at the time sequence Li-Fi), since the light sensing unit 120 and the light emitting unit 130 are in the idle state, the light sensing unit 120 and the light emitting unit 130 may then serve for performing ToF ranging. That is, the ToF ranging period (shown by the oblique lines at the time sequence ToF) and the optical communication period (shown by the oblique lines at the time sequence Li-Fi) are not overlapped and are interleaved according to the embodiment.

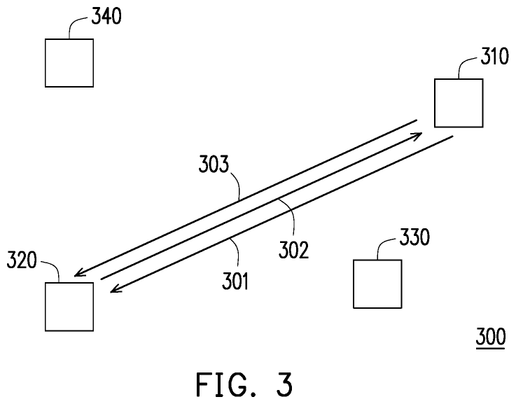

FIG. 3 is a schematic diagram of a multimedia system according to an embodiment of the disclosure. With reference to FIG. 3, a multimedia system 300 provided in the embodiment may be, for instance, a VR system or an AR system, and may include a plurality of electronic devices 310-340 are included. The electronic devices 310-340 may be wearable electronic devices, for instance. Each of the electronic devices 310-340 may include the ToF ranging module 100 and the wireless communication module 140 provided in the previous embodiment as depicted in FIG. 1. In the embodiment, the electronic devices 310-340 may communicate with each other through the wireless communication module to synchronize the ToF ranging periods and the optical communication periods of the electronic devices and determine the communication order of the electronic devices. For instance, the electronic devices 310-340 may determine that the electronic device 310 first performs ranging on the electronic device 320 and then provides the optical communication data to the electronic device 320. Therefore, as shown in FIG. 3, the light emitting unit of the electronic device 310 emits pulsed light 301 to the electronic device 320, and then the light sensing unit of the electronic device 310 receives pulsed light 302 reflected by the electronic device 320. The electronic device 310 may calculate the time difference between the pulsed light 301 and the pulsed light 302 to obtain the distance data between the electronic device 310 and the electronic device 320. Next, the electronic device 310 may emit an optical communication signal 303 to the electronic device 320 through the same light emitting unit or different light emitting units while calculating and outputting the distance data, so that the electronic device 310 may effectively and quickly provide other data to the electronic device 320. Note that the transmission speed of the optical communication data is actually faster than the transmission speed of data through normal wireless communication (such as Wi-Fi). Accordingly, the electronic devices of the multimedia system provided in the embodiment may effectively and quickly perform ranging and communication with each other and provide good user experience, and each electronic device does not need any additional functional module.

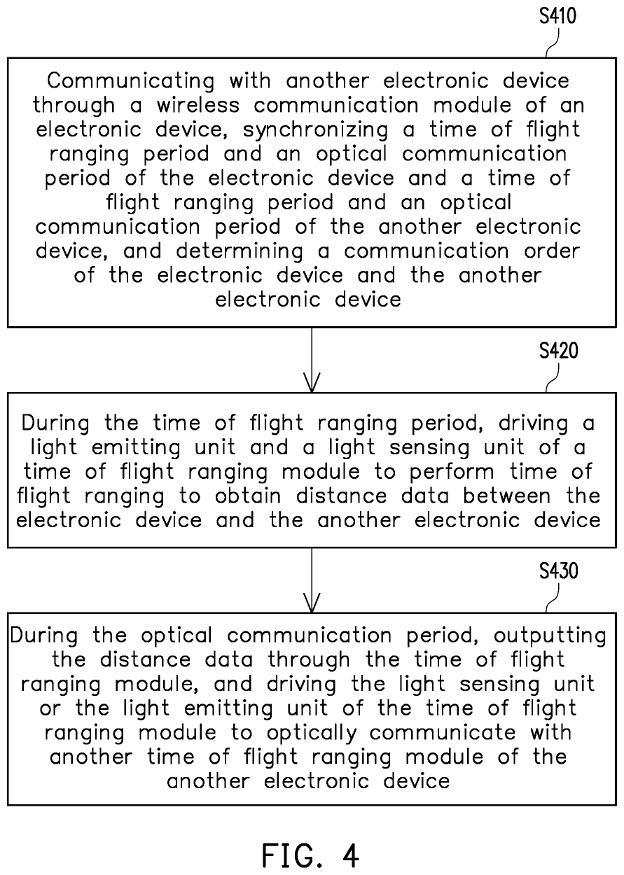

FIG. 4 is a flowchart of an operating method of a ToF ranging module according to an embodiment of the disclosure. With reference to FIG. 4, the operating method provided in the embodiment may be, for instance, applicable to the ToF ranging module 100 and the wireless communication module 140 provided in the embodiment as illustrated in FIG. 1. The ToF ranging module 100 is disposed on an electronic device and configured to sense another electronic device. In step S410, the wireless communication module 140 of the electronic device communicates with the another electronic device to synchronize a ToF ranging period and an optical communication period of the electronic device and a ToF ranging period and an optical communication period of the another electronic device and determine a communication order of the two electronic devices. In step S420, the ToF ranging module 100 drives the light emitting unit 130 and the light sensing unit 120 to perform ToF ranging during the ToF ranging period, so as to obtain distance data between the electronic device and the another electronic device. In step S430, the ToF ranging module 100 outputs the distance data during the optical communication period and drives the light sensing unit 120 or the light emitting unit 130 to optically communicate with another ToF ranging module of the another electronic device. Note that the ToF ranging period and the optical communication period are not overlapped and are interleaved. Therefore, the operating method and the ToF ranging module provided in the embodiment may perform an effective ToF ranging function and an effective optical communication function.

In addition, other module features, implementations, or technical details of the ToF ranging module provided in the embodiment may be referred to as those taught, disclosed, and suggested in the previous embodiments as depicted in FIG. 1 to FIG. 3 and thus will not be described hereinafter.

To sum up, the ToF ranging module, the operating method thereof, and the multimedia system provided in one or more embodiments of the disclosure may perform ToF ranging and optical communication in a time division manner with use of the light sensing unit and the light emitting unit of the ToF ranging module, so that the electronic device equipped with the ToF ranging module provided in one or more embodiments of the disclosure may perform effective and fast ToF ranging and optical communication functions.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A time of flight ranging module having an optical communication function and adapted to be disposed on an electronic device, the electronic device comprising a wireless communication module configured to communicate with another electronic device to synchronize a time of flight ranging period and an optical communication period of the electronic device and a time of flight ranging period and an optical communication period of the another electronic device and determine a communication order of the two electronic devices, the time of flight ranging module comprising:
a processing unit coupled to the wireless communication module;
a light sensing unit coupled to the processing unit; and
a light emitting unit coupled to the processing unit, wherein
during the time of flight ranging period, the processing unit drives the light emitting unit and the light sensing unit to perform time of flight ranging to obtain distance data between the electronic device and the another electronic device, and
during the optical communication period, the processing unit outputs the distance data and drives the light sensing unit or the light emitting unit to optically communicate with another time of flight ranging module of the another electronic device.

2. The time of flight ranging module according to claim 1, wherein during the time of flight ranging period, the light emitting unit emits sensing light to the another electronic device, and the light sensing unit receives reflected light reflected from the another electronic device.

3. The time of flight ranging module according to claim 2, wherein the processing unit calculates a distance between the electronic device and the another electronic device according to a difference between a time of emitting the sensing light by the light emitting unit and a time of receiving the reflected light by the light sensing unit.

4. The time of flight ranging module according to claim 1, wherein the time of flight ranging period and the optical communication period are not overlapped and are interleaved.

5. The time of flight ranging module according to claim 1, wherein the light sensing unit is a photodiode, and the light emitting unit is a light emitting diode or a laser diode.

6. The time of flight ranging module according to claim 1, wherein the electronic device and the another electronic device are operated in a virtual reality system or an augmented reality system.

7. A multimedia system comprising:
a first electronic device; and
a second electronic device, wherein
the first electronic device communicates with the second electronic device through a wireless communication module to synchronize a time of flight ranging period and an optical communication period of the first electronic device and a time of flight ranging period and an optical communication period of the second electronic device and determine a communication order of the first and second electronic devices,
the first electronic device performs time of flight ranging through a light emitting unit and a light sensing unit of a time of flight ranging module during the time of flight ranging period to obtain distance data between the first electronic device and the second electronic device, and
the first electronic device outputs the distance data through the time of flight ranging module during the optical communication period and optically communicates with another time of flight ranging module of the second electronic device through the light sensing unit or the light emitting unit.

8. The multimedia system according to claim 7, wherein during the time of flight ranging period, the light emitting unit of the first electronic device emits sensing light to the second electronic device, and the light sensing unit of the first electronic device receives reflected light reflected from the second electronic device.

9. The multimedia system according to claim 8, wherein a processing unit of the first electronic device calculates a distance between the first electronic device and the second electronic device according to a difference between a time of emitting the sensing light by the light emitting unit and a time of receiving the reflected light by the light sensing unit.

10. The multimedia system according to claim 7, wherein the time of flight ranging period and the optical communication period are not overlapped and are interleaved.

11. The multimedia system according to claim 7, wherein the light sensing unit is a photodiode, and the light emitting unit is a light emitting diode or a laser diode.

12. The multimedia system according to claim 7, wherein the multimedia system is a virtual reality system or an augmented reality system.

13. An operating method of a time of flight ranging module, the time of flight ranging module being disposed on an electronic device, the electronic device further comprising a wireless communication module, wherein the operating method comprises:
communicating with another electronic device through the wireless communication module of the electronic device, synchronizing a time of flight ranging period and an optical communication period of the electronic device and a time of flight ranging period and an optical communication period of the another electronic device, and determining a communication order of the electronic device and the another electronic device;
during the time of flight ranging period, driving a light emitting unit and a light sensing unit of the time of flight ranging module to perform time of flight ranging to obtain distance data between the electronic device and the another electronic device; and
during the optical communication period, outputting the distance data through the time of flight ranging module, driving the light sensing unit or the light emitting unit of the time of flight ranging module to optically communicate with another time of flight ranging module of the another electronic device.

14. The operating method according to claim 13, wherein during the time of flight ranging period, the step of driving the light emitting unit and the light sensing unit of the time of flight ranging module to perform the time of flight ranging comprises:
emitting sensing light to the another electronic device by the light emitting unit; and
receiving reflected light reflected from the another electronic device by the light sensing unit.

15. The operating method according to claim 14, wherein the step of obtaining the distance data between the electronic device and the another electronic device comprises:
calculating a distance between the electronic device and the another electronic device according to a difference between a time of emitting the sensing light by the light emitting unit and a time of receiving the reflected light by the light sensing unit.

16. The operating method according to claim 13, wherein the time of flight ranging period and the optical communication period are not overlapped and are interleaved.

17. The operating method according to claim 13, wherein the light sensing unit is a photodiode, and the light emitting unit is a light emitting diode or a laser diode.

18. The operating method according to claim 13, wherein the electronic device and the another electronic device are operated in a virtual reality system or an augmented reality system.
